(19) United States
(12) Patent Application Publication
(10) Pub. No.: US 2015/0104101 A1
(43) Pub. Date: Apr. 16, 2015

(54) METHOD AND UI FOR Z DEPTH IMAGE SEGMENTATION

(71) Applicant: Apple Inc., Cupertino, CA (US)

(72) Inventors: Andrew E. Bryant, Los Gatos, CA (US); Daniel Pettigrew, Pacific Palisades, CA (US)

(73) Assignee: Apple Inc., Cupertino, CA (US)

(21) Appl. No.: 14/053,581

(22) Filed: Oct. 14, 2013

(51) Int. Cl. G06K 9/46; G06T 7/00

(52) U.S. Cl. CPC G06K 9/4642; G06T 7/0051
USPC 382/171

(57) ABSTRACT

An application that receives and edits image data from a light field camera. The application determines a distance from the light field camera for each portion of the image. The application of some embodiments uses the depth information to break the image data down into layers based on the depths of the objects in the image. In some embodiments, the layers are determined based on a histogram that plots the fraction of an image at a particular depth against the depths of the image.

### BACKGROUND

When a camera takes a photograph, parts of the scene within view of the camera are closer to the camera than other parts of the scene. The distance of an object in a scene from a camera is sometimes referred to as the “depth” of that object. The farther an object is from the camera, the greater the depth of the object.

Standard cameras can only focus on one depth at a time. The distance from the lens of the camera to the depth that is in perfect focus is called the “focusing distance”. The focusing distance is determined by the focal length of the lens of the camera (a fixed property for lenses that do not change shape) and the distance of the lens from the film or light sensor in the camera. Anything closer to or farther from the lens than the focusing distance will be blurred. The amount of blurring will depend on the distance from the focusing distance to the object and whether the object is between the camera and the focusing distance or farther away from the camera than the focusing distance. In addition to the distance that is in perfect focus, there are some ranges of distances on either side of that perfect focus in which the focus is close to perfect and the blurring is imperceptible or is acceptably low.

Distinct from ordinary cameras which capture images with a single depth of focus for a given image, there are “light field cameras”. Light field cameras determine the directions from which rays of light are entering the camera. As a result of these determinations, light field cameras do not have to be focused at a particular focusing distance. A user of such a camera shoots without focusing first and sets the focusing distance later (e.g., after downloading the data to a computer).

### BRIEF SUMMARY

In some embodiments, an application (e.g., an image organizing and editing application) receives and edits image data from a light field camera. The image data from the light field camera includes information on the direction of rays of light reaching the camera. This information lets the application determine a distance from the light field camera (a “depth”) for each portion of the image (e.g., a depth of the part of the scene that each pixel in an image represents). The applications of some embodiments use the depth information to break the image data down into layers based on the depths of the objects in the image. In some embodiments, the layers are determined based on a histogram that plots the fraction of an image at a particular depth against the depths of objects in the image.

In some embodiments, the applications provide a control for setting a depth at which a foreground of the image is separated from the background of the image. The applications of some such embodiments obscure the objects in the designated background of the image (e.g., by graying out the pixels representing those objects or by not displaying those pixels at all). In some such embodiments, an initial setting for the control is based on the determined layers (e.g., the initial setting places the first layer in the foreground, or the last layer in the background, or uses some other characteristic(s) of the layers to determine the default value).

The applications of some embodiments also provide layer selection controls that allow a user to command the applications to hide or display particular layers of the image. In some such embodiments, the number of layers and the number of layer selection controls vary based on the depths of the objects in the image data.

In some embodiments, the applications provide controls that allow a user to select objects for removal from an image. In some such embodiments, the applications remove the selected object by erasing a set of pixels that are (i) in the same layer as a user selected portion of an image, and (ii) contiguous with the selected portion of the image.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE FIGURES

The novel features of the invention are set forth in the appended claims. However, for purpose of explanation, several embodiments of the invention are set forth in the following figures.

FIG. 1 conceptually illustrates multiple stages in the taking and editing of image data captured with a light field camera.

FIG. 2 conceptually illustrates a process of some embodiments for receiving and analyzing image data from a light field camera.

FIG. 3 conceptually illustrates the generation of a histogram of some embodiments.

FIG. 4 conceptually illustrates a process of some embodiments for generating a histogram of depth versus portion of the image at a given depth.

FIG. 5 conceptually illustrates breaking image data down into layers using a histogram.

FIG. 6 conceptually illustrates a process of some embodiments for determining layers of a histogram.

FIG. 7 conceptually illustrates a process of some embodiments for providing user controls with default values set according to determined layers.

FIG. 8 illustrates a depth display slider of some embodiments for obscuring background layers by graying out the background layers.

FIG. 9 illustrates multiple stages of an alternate embodiment (to the embodiment of FIG. 8) in which portions of the image in the background are not displayed at all, rather than being displayed as grayed out.

FIG. 10 illustrates an embodiment in which the user selects a layer by selecting an object in that layer.

FIG. 11 conceptually illustrates a process of providing and using layer selection controls.

FIG. 12 illustrates layer selection controls of some embodiments and their effects on a displayed image.

FIG. 13 illustrates the removal of an object from an image.

FIG. 14 conceptually illustrates a process for removing an object from an image.

FIG. 15 illustrates an image organizing and editing application of some embodiments.

FIG. 16 conceptually illustrates a software architecture of some embodiments.

FIG. 17 is an example of an architecture of a mobile computing device on which some embodiments are implemented.

FIG. 18 conceptually illustrates another example of an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to be identical to the embodiments set forth and that the invention may be practiced without some of the specific details and examples discussed. It will be clear to one of ordinary skill in the art that various controls depicted in the figures are examples of controls provided for reasons of clarity. Other embodiments may use other controls while remaining within the scope of the present embodiment. For example, a control depicted herein as a hardware control may be provided as a software icon control in some embodiments, or vice versa. Similarly, the embodiments are not limited to the various indicators depicted in the figures. For example, in some embodiments the background is overlain in some color other than gray (e.g., showing background areas in sepia tones instead of graying out the areas).

Applications of some embodiments for organizing, viewing, and editing images can receive light field data (i.e., data recorded by a light field camera that corresponds to light from a scene photographed by the light field camera) and use that data to generate images with any given focusing distance. In addition, the applications of some embodiments can also identify the distance of any particular part of the image data from the light field camera based on the focusing distance at which that part of the image data becomes focused. The applications of some embodiments can use the ability to identify distances of portions of the image to separate the image into discrete layers with objects at different depths in the image data being separated into different layers.

As used herein, “image data” or “light field image” refers to all the visual data collected by a light field camera when it captures light from a scene (e.g., when the light field camera is activated). Because the image data contains information that can be used to generate a variety of images, with different focusing distances and slightly different perspectives, the image data is not just an image such as is taken by a conventional camera.

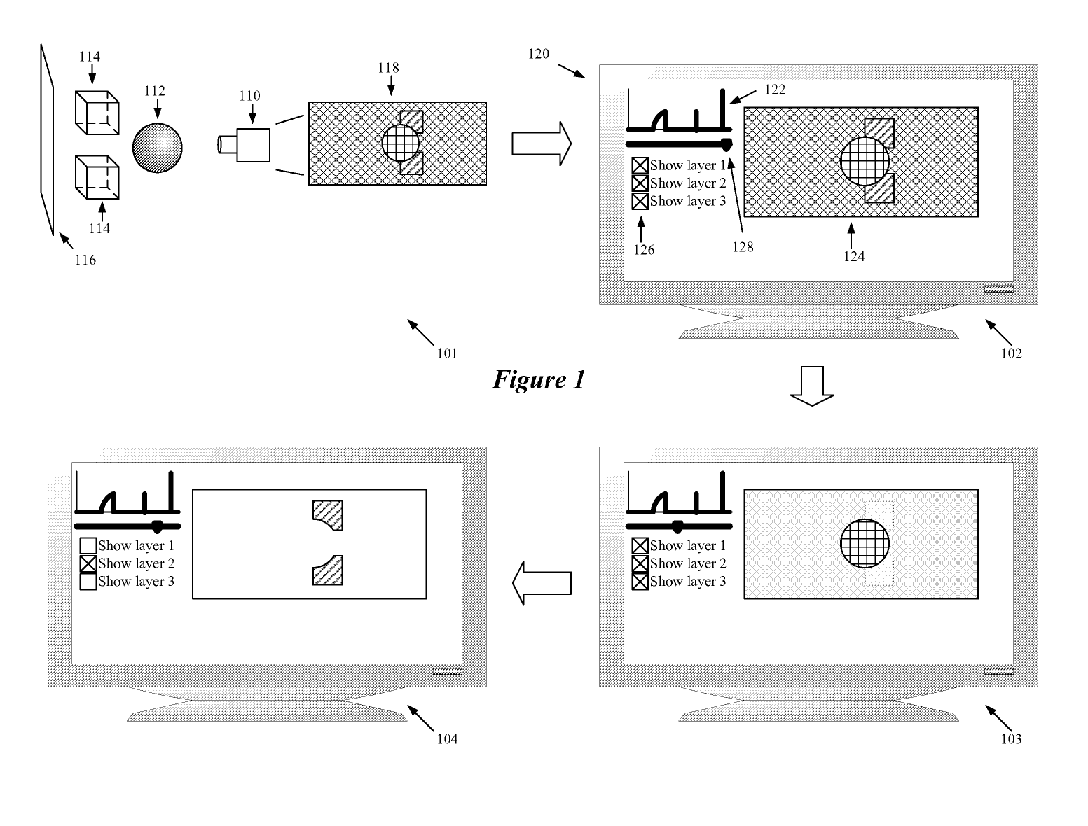

FIG. 1 conceptually illustrates multiple stages 101-104 in the taking and editing of image data captured with a light field camera. The first stage 101 shows the initial capture of a scene (e.g., the set of objects, people, etc., in front of the light field camera) by a light field camera. Stages 102-104 illustrate various operations performed on the captured image data by an image viewing, organizing, and editing application of some embodiments.

In stage 101, a light field camera 110 captures a scene with a sphere 112, two cubes 114, and a wall 116. The sphere 112 is between the camera 110 and the cubes 114 and partially blocks the camera's view of the cubes. The cubes 114 and the sphere 112 all partially block the camera's view of the wall 116. The light field camera 110 captures a light field image 118.

The light field image 118 contains all the visual data of the scene as viewed by the light field camera. The captured data in the light field image contains more than an image at a particular focus. A light field camera is different from a standard camera, which captures only one depth of focus clearly and captures all other depths of focus blurrily. A light field camera captures light from all depths of focus clearly at the same time. The camera 110 is a light field camera and therefore captures the light clearly from every focusing depth of the entire scene rather than capturing sharp images from a specific depth of focus (focusing distance) and blurry images of anything not at that specific depth.

The light field image 118 captured by camera 110 is sent to application 120 in stage 102. The light field image 118 includes visual data about the wall 116, the cubes 114 in front of the wall 116, and the sphere 112 in front of the cubes 114. The application 120 generates and displays a histogram 122 of the light field image 118. The application 120 also displays a representation image 124, layer selection controls 126, and a depth display slider 128.

The histogram 122 measures depth along the horizontal axis and number of pixels (or the fraction of the image data) at a given depth along the vertical axis. In some embodiments, the application 120 analyzes the histogram to identify peaks which represent large numbers of pixels which in turn represent objects at a particular distance from the light field camera 110. Here, the leftmost, curved peak on the histogram 122 shows the portion of the pixels that represent the sphere 112. The middle peak of histogram 122 shows the portion of the pixels representing the two cubes 114. The rightmost peak of histogram 122 shows the portion of the pixels representing the wall 116. The illustrated peaks are not drawn to scale. In some embodiments, the application 120 identifies multiple layers in the image based on peaks and/or valleys of the histogram. Each layer represents a contiguous range of depths within the scene, although there may not be objects at all depths of a given layer. In some embodiments, the application 120 generates a layer surrounding each peak that is at or above a particular threshold height. In some embodiments, layers may encompass sets of depths that encompass multiple peaks.

In some embodiments, the representation image 124 is an image generated from data of the light field image 118. The representation image 124 in some embodiments shows the scene with a particular depth of focus. In some embodiments, application allows the user to adjust the depth of focus. The layer selection controls 126 allow the user to show or hide different layers (e.g., different sets of depth ranges). In some embodiments, the layer selection controls 126 are generated based on the histogram. Different captured scenes result in different histograms with (potentially) different numbers of layers. In some embodiments, the application 120 generates a layer selection control 126 for each identified layer of the image. In stages 102 and 103, the layer selection controls 126 are set to show all layers (i.e., all three layer selection controls are checked).

The layer selection controls 126 described above determine whether a layer will be displayed or removed entirely. In contrast, some embodiments also (or instead) provide a depth display slider 128 that determines whether particular depths will be shown grayed out (e.g., background depths) or not grayed out (e.g., foreground depths). In some such embodiments, a layer can be shown or removed entirely on the basis of the layer selection controls 126. In some such embodiments, if a layer is set to be shown at all, then the layer can be shown as grayed out or not grayed out based on the depth display slider 126. In some embodiments, the depth display slider 128 can be set in the middle of a layer as well as in back of or in front of a layer. In the embodiment of FIG. 1, the image 124 is divided into a foreground and a background by the setting of the depth display slider 128. Portions of the image 124 in the foreground are shown normally and portions of the image 124 in the background are shown as grayed out.

In the illustrated embodiment, the depth at which the image 124 is divided between the foreground and the background is determined by the depth display slider 128. The farther to the right the depth display slider 128 is set, the more of the image is in the foreground and thus shown normally. Additionally, the farther to the right the depth display slider 128 is set, the less of the image is in the background and thus shown grayed out. In stage 102, the slider 128 is set at the rightmost extreme and image 124 shows the entire image without any grayed out areas.

In stage 103, the slider 128 is set in the middle of the histogram 122. The slider is set between the peak representing the sphere and the peak representing the cubes. Accordingly, the application displays the entire sphere 112 in the foreground and the rest of the image in the background (i.e., grayed out). In some embodiments, unlike the embodiment illustrated in FIG. 1, the slider 128 is not aligned with the histogram.

In stage 104, the slider 128 is set to the right of the peak representing the cubes 114. Therefore, the cubes are shown without being grayed out. In this stage the layer selection controls 126 are set to display only the second layer (i.e., the first and third layer selection controls are unchecked and the second layer control is checked). Therefore, the application does not display the first layer, which encompasses the sphere 112 or the third layer, which encompasses the wall 116. The application 120 displays those parts of the representation image 124 that are in the second layer, here the pixels of cubes 114. Neither the sphere 112 nor the wall 116 themselves are shown as they are in layers that are hidden during this stage 104. At the time the scene was captured by the light field camera 110 in stage 101, the camera's view of the cubes 114 was partially blocked by the sphere 112. Therefore, the camera was unable to collect any data about the portion of the cubes 114 that was hidden behind the sphere 112. Accordingly, the display of the second layer includes only those portions of the cubes that were visible to the camera 110. Thus, the cubes shown in the image 124 have curved voids where the sphere 112 had been displayed. However, in some embodiments, parts of deeper layers that are blocked in a representation image 124 are visible when shallower layers are hidden.

Section I, below, explains how depth histograms are generated and analyzed in some embodiments. Section II then describes how layers are determined. Section III then describes depth controls. Section IV describes object removal. Section V describes an image organizing and editing application of some embodiments. Section VI describes a mobile device used to implement some embodiments. Finally, Section VII describes a computer system used to implement some embodiments.

### I. Analysis of Histograms

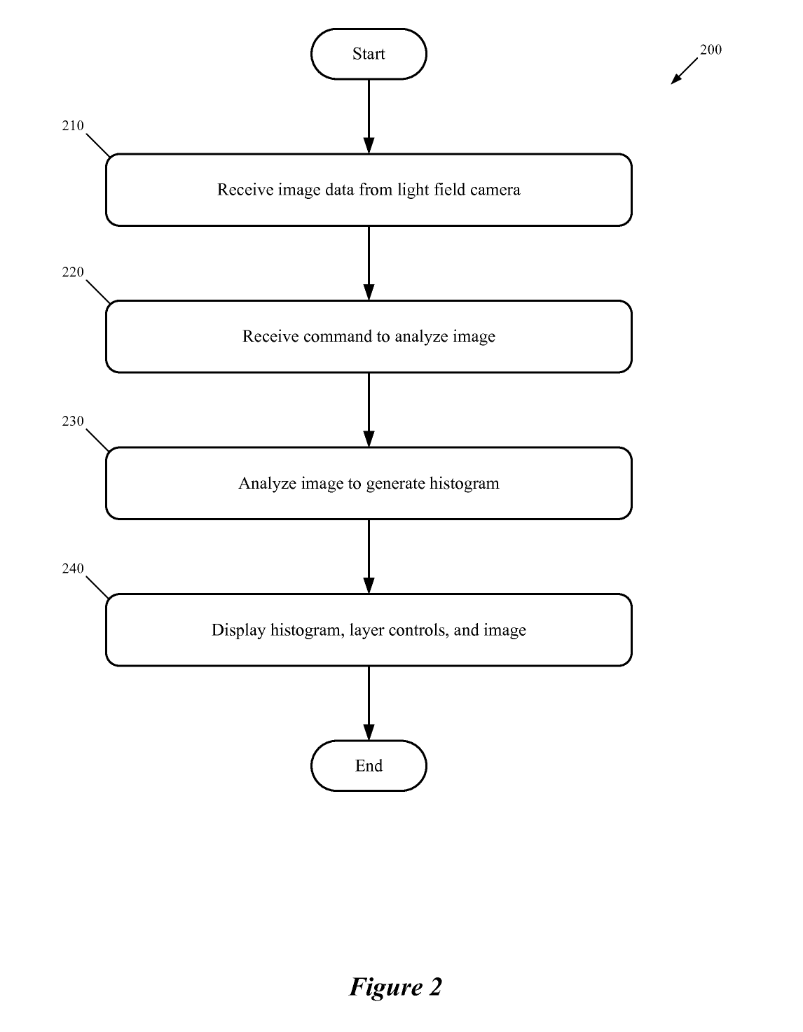

As mentioned above with respect to FIG. 1, the applications of some embodiments analyze histograms of depth versus portion of the image data at those depths to identify layers of the image data. FIG. 2 conceptually illustrates a process 200 of some embodiments for receiving and analyzing image data from a light field camera. The process 200 receives (at 210) image data from a light field camera. The image data includes information about the directions and (in color light field cameras) colors of multiple rays of light that enter the light field camera. The image data is more than the data used to depict a single image. The image data allows the image organizing and editing application of some embodiments to generate an image at any desired focusing distance. In some embodiments, the image editing application selects a default focusing depth and displays an image using the image data and the selected focusing depth at this stage. The process 200 then receives (at 220) a command to analyze the image data. The command may come from a user, or as an automatic function of the image editing application in some embodiments. In some embodiments, a user selects an option to have the application automatically analyze any set of image data received (directly or indirectly) from a light field camera.

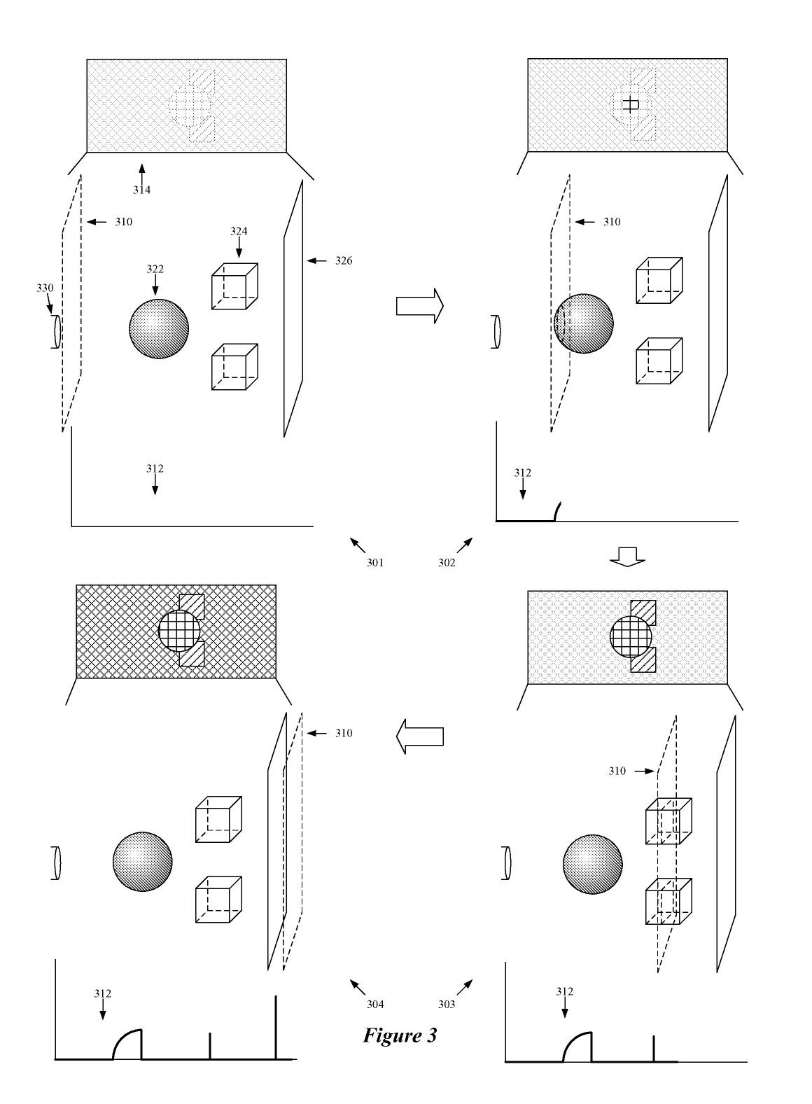

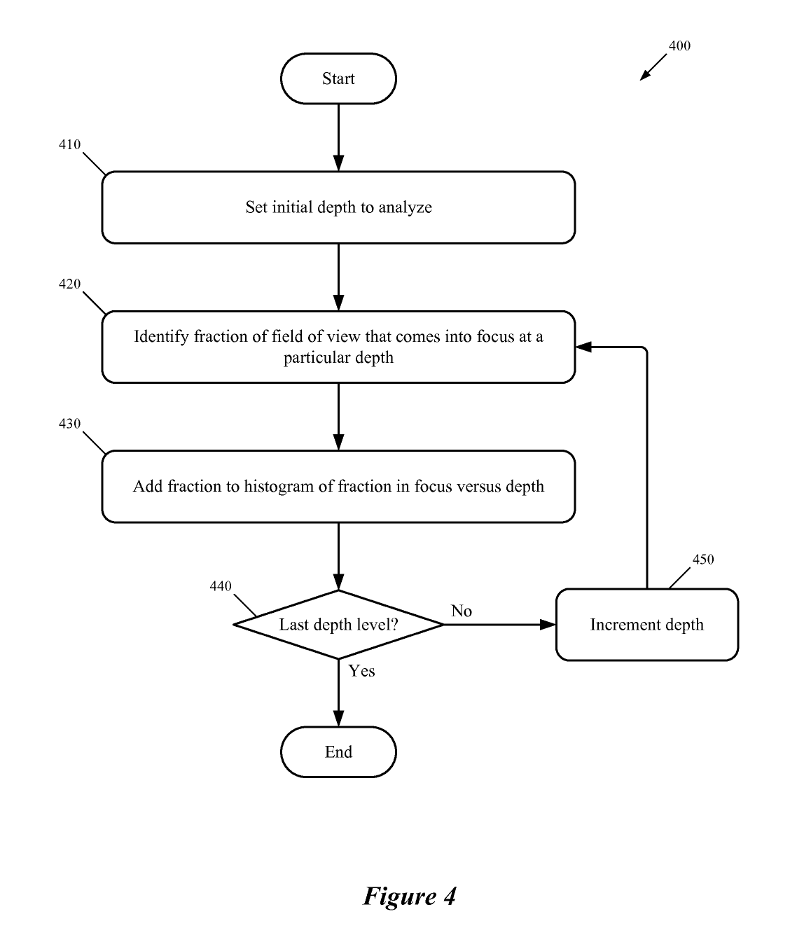

The process 200 then analyzes the image data to generate (at 230) a histogram of depth versus number of pixels. In some embodiments, the process generates the histogram using the process described with respect to FIGS. 3 and 4, below. In some embodiments, at the stage of generating the histogram, the process 200 also analyzes the histogram to identify different layers of objects in the image. Each layer represents a range of depths surrounding one or more peaks of the histogram. In some embodiments, the process smoothes out the histogram before analyzing it for peaks and valleys.

The process 200 then displays (at 240) the histogram, layer controls, and an image derived from the image data received from the light field camera. The image data includes enough information to allow the image editing application to display multiple images of the photographed scene at different focusing depths. In some embodiments, the image is displayed using a focusing depth near or at the depth represented by one of the peaks of the histograms. In some embodiments, the image is displayed using a depth at or near the largest peak. In other embodiments the image is displayed using a depth of the closest peak to the camera, the closest peak over a threshold height, or the first peak over a threshold overall area of the histogram, etc. In some embodiments, the user decides whether or not the histogram should be displayed. That is, although the process 200 as illustrated displays the histogram, in some embodiments, the user determines through a setting or control whether the histogram will be visibly displayed. In some embodiments, the layer controls include a control for displaying or hiding each of the layers identified when generating the histogram. In some embodiments, the layer controls include a depth display slider that allows the user to set a depth at which the foreground is separated from the background.

FIG. 3 conceptually illustrates the generation of a histogram 312 of some embodiments. The figure is shown in four stages 301-304. In each successive stage, more of the histogram 312 has been generated. Each stage includes a plane 310 representing a depth (relative to the light field camera 330) at which the image is being analyzed during that stage, a histogram 312 showing the progress up to that point, an image 314 that shows which portions of the scene have already been analyzed at each stage, and the scene with the sphere 322, the two cubes 324, and the wall 326. One of ordinary skill in the art will understand that the scene is shown at right angles to the view of the light field camera 330 in the stages 301-304 of this figure for reference, and not because the camera 330 captures every part of the scene. That is, in some embodiments the light field camera 330 does not capture data about the portion of the sphere 322 which is hidden from the light field camera 330 by the front of the sphere 322 or the portions of the wall 326 hidden from the light field camera 330 by the cubes 324 and the sphere 322, etc.

In stage 301, the plane 310 is at the front of the scene, at a location corresponding to the camera 330. There are no objects at this depth (zero depth) therefore the histogram 312 shows a point at the zero-zero coordinates of the histogram. In stage 301, none of the image has been analyzed, so the entire image 314 is shown as grayed out. One of ordinary skill in the art will understand that while the application of some embodiments displays an image 314 that shows progressively which parts of the image are within the depth already plotted on the histogram 312, other embodiments do not show such an image while generating the histogram 312.

In stage 302, the plane 310 has advanced into the scene, indicating that the depths between zero and the position of the plane 310 have already been analyzed. In stage 302, the plane has intersected the front of the sphere 322. Analysis of the image at the indicated depth will identify a ring of pixels making up part of the sphere 322 as being in focus at that depth. Accordingly, the application plots a point on the histogram corresponding to that depth along the horizontal axis and at a height proportional to the number of pixels in focus (at that depth) along the vertical axis. For sphere 322, the number of pixels in focus (i) begins to rise above zero when the plane 310 first reaches the sphere 322, (ii) expands as the plane moves through the sphere (as larger and larger slices of the sphere 322 come into focus as the depth increases), then (iii) abruptly drops to zero at a depth corresponding to just after the halfway point of the sphere 322 because the back of the sphere is hidden from the camera by the front of the sphere 322. In stage 302 a portion of the image up to part of the sphere has been analyzed, so most of the image 314 is shown as grayed out, but the part of the sphere 322 that is within the analyzed depth is shown without being grayed out.

The peak on the histogram generated by the sphere is completed between stages 302 and 303. In stage 303, the plane 310 has passed the front (relative to the camera) faces of the cubes 324 and the application has added the pixels from the front faces of the cubes 324 to the histogram 312. The front faces of the cubes 324 are at right angles to the line of sight of the light field camera 330 that took the image, therefore, the pixels in the front faces of the cubes 324 are all at or close to the same distance away from the light field camera 330. Because most or all of the face of the cubes 324 are the same distance from the light field camera 330, the peak on the histogram corresponding to the faces of the cubes is a sharp spike. Because the rest of the bodies of the cubes 324 are hidden from the camera by the faces of the cubes, the histogram level returns to zero for depths corresponding to the bodies of the cubes. In stage 303 the portion of the image up to the bodies of the cubes 324 have been analyzed, so all of the image 314 except the wall 326 (i.e., the sphere 322 and the cubes 324) is shown without being grayed out.

In stage 304, the plane 310 has passed the wall 326. The histogram 312 shows a large spike at a depth corresponding to the depth of the wall 326. In this scene, the wall 326 blocks off any view of larger distances. Accordingly, the histogram shows zero pixels at depths greater than the depth of the wall 316. As all objects visible to the light field camera 330 have been analyzed, image 314 is shown in stage 304 with none of the image 314 grayed out.

Various embodiments use various processes to analyze the histogram. FIG. 4 conceptually illustrates a process 400 of some embodiments for generating a histogram of depth versus portion of the image at a given depth. The process 400 sets (at 410) an initial depth to analyze within the image data from the light field camera. The initial depth in some embodiments is zero. In other embodiments, the initial depth is the maximum depth of focusing distance for the light field camera (i.e., the depths are analyzed from the back of the field of view in such embodiments). The process 400 then identifies (at 420) the portion of the field of view that is in focus at the particular depth.

The process 400 then adds (at 430) the portion of the field of view in focus at the particular depth to the histogram at the particular depth level. In some embodiments, the portion is measured as a percentage or fraction of the total image data area, in other embodiments the portion is measured in the number of pixels that are in focus at a particular depth.

After adding the portion at a particular depth, the process 400 then determines (at 440) whether the particular depth was the last depth to be analyzed. In some embodiments, the last depth is the closest depth to the light field camera. In other embodiments the last depth is the farthest depth of the light field camera. When the process 400 determines (at 440) that there are additional depths to analyze, the process 400 increments (at 450) the depth, then loops back to operation 420 to identify the portion of the field of view in focus at that depth. When the process 400 determines (at 440) that there are no additional depths to analyze, the process 400 ends.

### II. Layer Determination

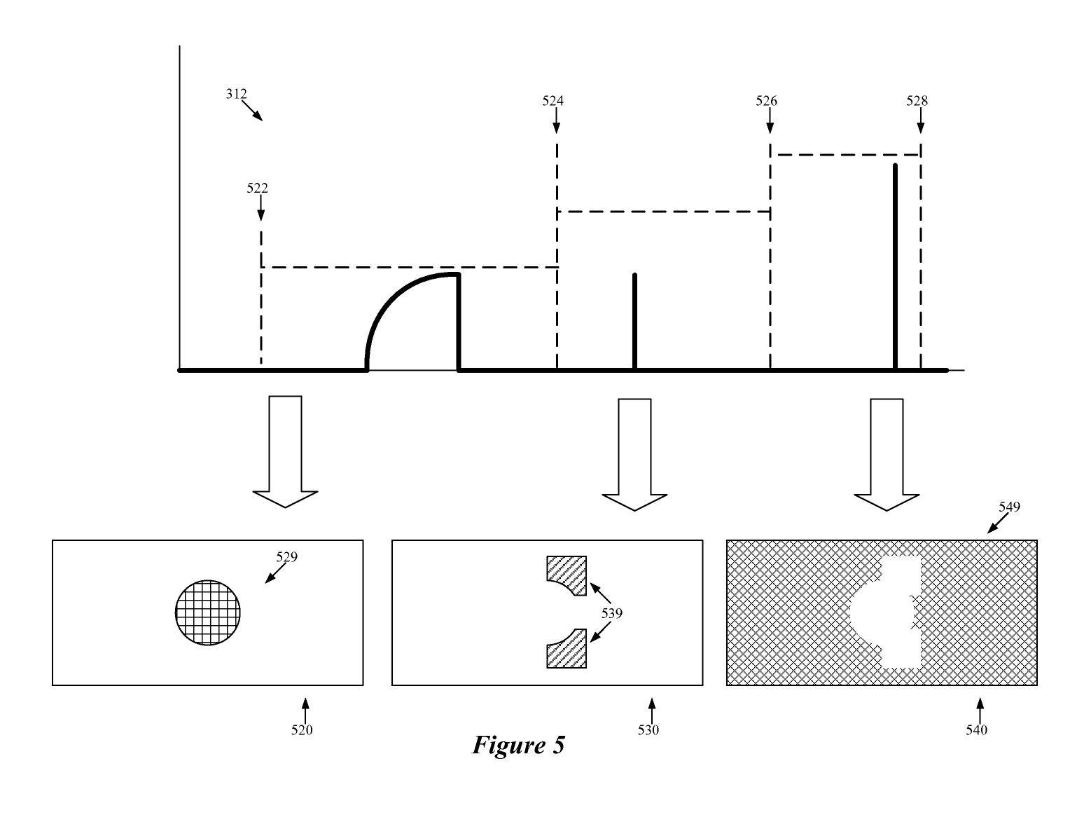

After a histogram is generated, the applications of some embodiments analyze the histogram to break it down into layers. FIG. 5 conceptually illustrates breaking image data down into layers using a histogram. The figure includes histogram 312 and layers 520, 530, and 540. Histogram 312 is the same as the histogram generated in FIG. 3 from the scene with sphere 322, cubes 324, and wall 326.

The first layer 520 comprises the depths from depth 522 to depth 524. The depth 522 is a depth in the first (least depth) low pixel area of the image. In this case, there are no pixels (and therefore no objects) at a depth between the light field camera (not shown) and the start of the first object (sphere 322). The starting depth 522 for the first layer 520 is a depth between the light field camera and the start of the first object (the point at which the histogram 312 begins to rise). In some embodiments, the start of the first layer is at the position of the light field camera (zero depth). In other embodiments, the first layer starts at a preset distance before the first peak. In still other embodiments, the first layer starts at other depths (e.g., halfway from zero depth to the depth of the first peak, at the depth that the histogram first shows any pixels in focus, a depth where (or at a certain distance before) the histogram begins to rise at faster than a threshold rate, etc.).

The depth 524 is a depth in the second (second least depth) low pixel area. The depth 524 is the end of the first layer 520 and the start of the second layer 530. The depth 524 lies between the first peak and the start of the second object (e.g., the point at which the histogram begins to rise again after dropping from the first peak). In some embodiments, the end of the first layer 520 is at the bottom of a valley between two peaks. In other embodiments, the first layer 520 ends at a preset distance after the first peak. In still other embodiments, the first layer ends at other depths (e.g., halfway from the first peak's depth to the depth of the second peak, at the depth that the histogram begins to rise after the lowest point between two peaks, when the histogram begins to rise at faster than a threshold rate after the first peak, a certain distance before the histogram begins to rise at faster than a threshold rate after the first peak, etc.).

The first layer 520 includes all the portions of the image which come into focus at depths between the starting depth 522 of the first layer 520 and the ending depth 524 of the first layer 520. In this example, the only object in the first layer is the sphere 322 of FIG. 3. Therefore, the only object shown in layer 520 is the sphere (represented in FIG. 5 as a circle 529 with a vertical and horizontal crosshatch pattern).

In the embodiment of FIG. 5, the second layer 530 comprises the depths from depth 524 to depth 526. Some embodiments use the same or similar criteria for determining the starting and ending depths of subsequent layers as for determining the starting and ending depths of the first layer. In this case, there are no pixels (and therefore no objects) at a depth between the deepest parts of the sphere 322 (as seen in FIG. 3) that is visible to the light field camera and the start of the second set of objects (cubes 324, as seen in FIG. 3). The starting depth 524 for the second layer 530 is a depth between the peak on the histogram 312 representing the sphere 322 of FIG. 3 and the start of the second object (in this case, the depth at which the histogram 312 shows a short spike representing the cubes 324 of FIG. 3).

In some embodiments, the start of the second layer is at the position of the end of the first layer. However, in some embodiments, the ending depth of one layer may not be at the position of the start of the next layer. For example, in some embodiments, the second layer starts at a preset distance before the second peak. In still other embodiments, the second layer starts at a preset depth beyond the first peak or at other depths (e.g., halfway from the depth of the first peak to the depth of the second peak, at the depth that the histogram first shows any pixels in focus after the first peak, where the histogram begins to rise from a valley after the first peak at faster than a threshold rate, etc.).

The depth 524, the starting depth of second layer 530, is a depth in the second (second least depth) low pixel area. The ending depth 526 of the second layer 530 (which is also the starting depth of the third layer 540) is a depth between the second peak and the start of the wall 326 of FIG. 3. In some embodiments, the end of the second layer is at the bottom of a valley (e.g., a local minimum) between the second and third peaks. In other embodiments, the second layer ends at a preset distance after the second peak. In still other embodiments, the second layer ends at other depths.

The second layer 530 includes all the portions of the image which come into focus at depths between the starting depth 524 of the second layer 530 and the ending depth 526 of the second layer 530. In this example, the only objects in the second layer are the cubes 324 of FIG. 3. Therefore, the only objects shown in layer 530 are the portions of the cubes visible from the position of the light field camera. The portions of the cubes 324 shown in FIG. 5 are represented by partial squares 539 with circular voids (the voids represent the portions of the cubes 324 blocked by the sphere 322 of FIG. 3). The partial squares 539 are shown with a diagonal line pattern to distinguish them from the circle 529 with vertical and horizontal crosshatch pattern when the squares 539 and the circle 529 are drawn simultaneously. One of ordinary skill in the art will understand that the patterns are included for conceptual reasons, not because the applications of all embodiments put different patterns on different layers. However, embodiments that put different patterns on different layers are within the scope of the inventions described herein.

The third layer 540 begins at depth 526 and ends at depth 528. In some embodiments, the final layer of the image ends at a depth beyond which there are no further pixels in the image data captured by the light field camera. In other embodiments, the final layer ends at a maximum allowable depth of the image data captured by the light field camera. The only object in the third layer 540 is the wall 326 of FIG. 3. Therefore the layer 540 shows the wall with voids representing the sphere 322 and cubes 324 that block a portion of the wall from the light field camera in FIG. 3. The wall 549 is shown with a diagonal crosshatch pattern to distinguish it visually from the circle 529 and the partial cubes 539.

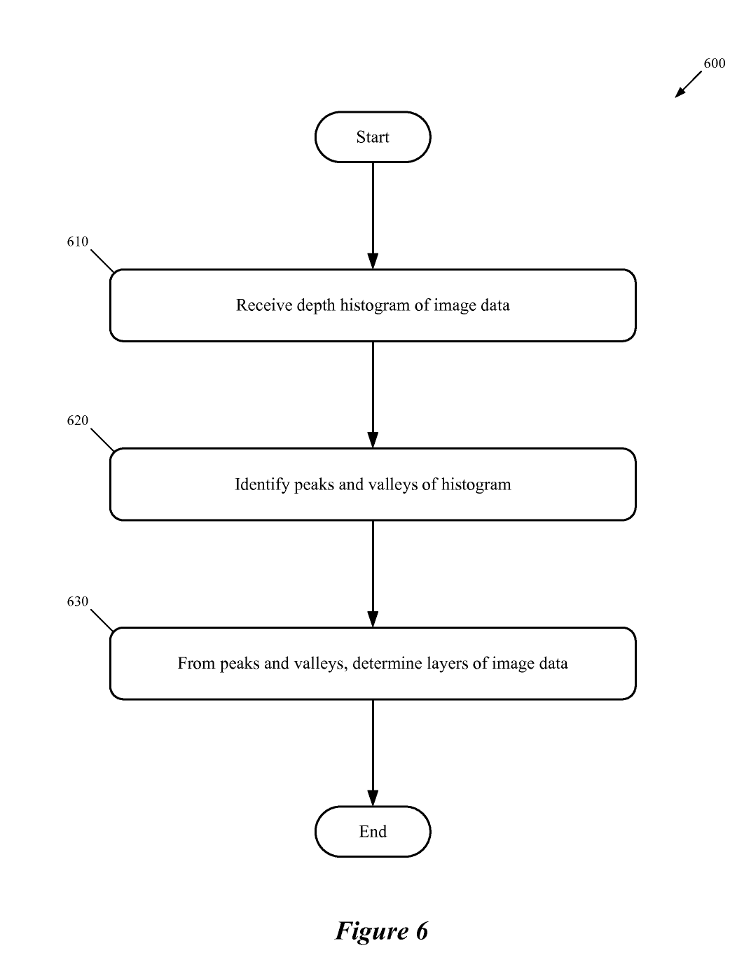

FIG. 6 conceptually illustrates a process 600 of some embodiments for determining layers of a histogram. The process 600 receives (at 610) a depth histogram of image data (e.g., image data captured by a light field camera). In some embodiments, the received histogram is generated by a module of an image organizing and editing application and received by another module of the image organizing and editing application. The received histogram is a histogram of pixels versus depth that identifies the proportion of the image data that is found at each depth (e.g., distance from the light field camera that captured the image data).

The process 600 then identifies (at 620) peaks and valleys in the histogram. A peak represents a depth at which a local maximum is found on the histogram. That is, a location at which the proportion of the image found at a given depth stops increasing and starts decreasing. In some cases, the peak can be very sharp (e.g., where images of surfaces at right angles to the line of sight of the light field camera are captured) and in other cases, the peak may be more gentle (e.g., where surfaces are rounded or are angled toward or away from the line of sight of the light field camera). In some embodiments, the process smoothes out the histogram before analyzing it for peaks and valleys.

Using the peaks and valleys of the histogram, the process 600 determines (at 630) the layers of the image data. In some embodiments, the process 600 may divide the image data into two layers, or any other preset number of layers. In other embodiments, the process may divide the image data into a number of layers that depends on the number of peaks and/or the number of valleys in the data. In still other embodiments, the process may divide the image into layers based on the number of peaks above a certain threshold height. After determining (at 630) the layers of the image data, the process 600 ends.

### III. Depth Controls

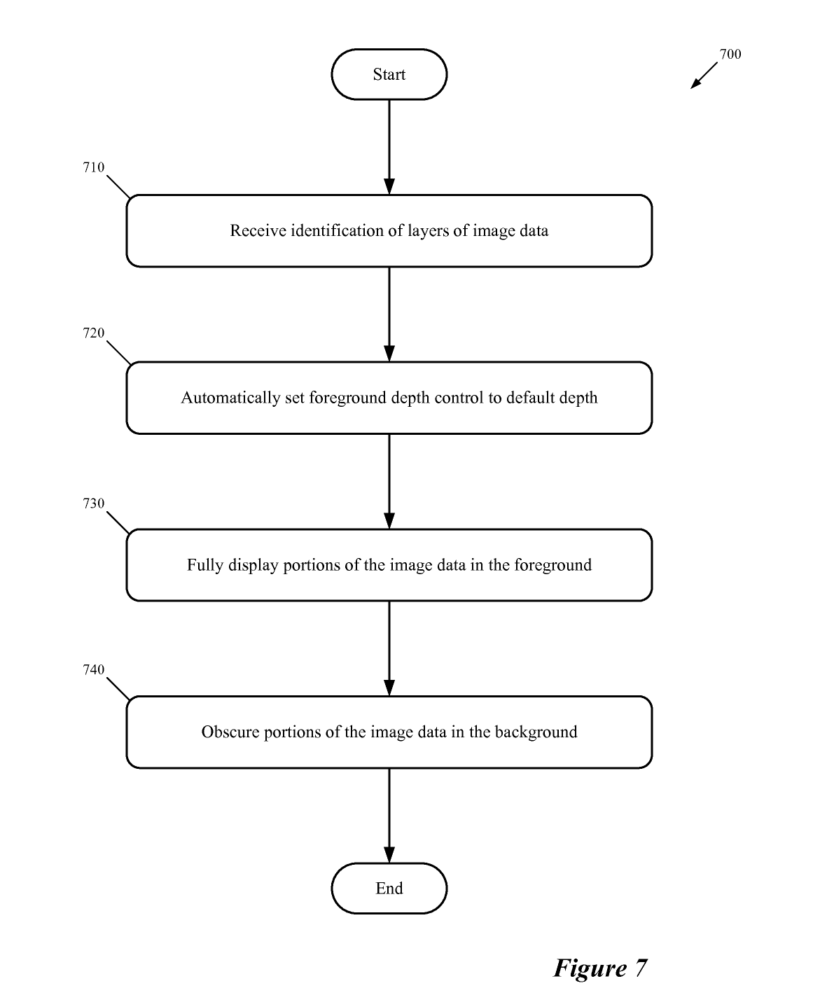

After the layers are determined, some embodiments provide various user controls relating to the layers and in some cases set default values for one or more controls based on the determined layers. FIG. 7 conceptually illustrates a process 700 of some embodiments for providing user controls with default values set according to the determined layers (e.g., layers determined by process 600 of FIG. 6). The process 700 receives (at 710) an identification of layers of image data (e.g., image data captured by a light field camera). In some embodiments, these layers are determined by a process such as process 600 of FIG. 6. Layer identification may be received from a module of an image organizing and editing application by another module of the image organizing and editing application. The received layer identification may include two or more layers, depending on the image data and the histogram based on the image data.

In some embodiments, the application provides a depth display control that determines a depth on either side of which portions of the image will be treated differently. For example, a depth control of some embodiments determines which depth will be treated as foreground (e.g., fully displayed) and which depths will be treated as background (e.g., obscured). The process 700 automatically sets (at 720) a depth control to a default depth. In some embodiments, the default depth will be the depth where one set of layers ends and another set of layers begins. For example, with an image of a person standing in front of a distant building, the default depth of the foreground control in some embodiments is set between the layer with the person and the layer with the building. The process then fully displays (at 730) portions of the image data that are in the foreground and partially obscures (at 740) portions of the image data that are in the background. The process 700 then ends.

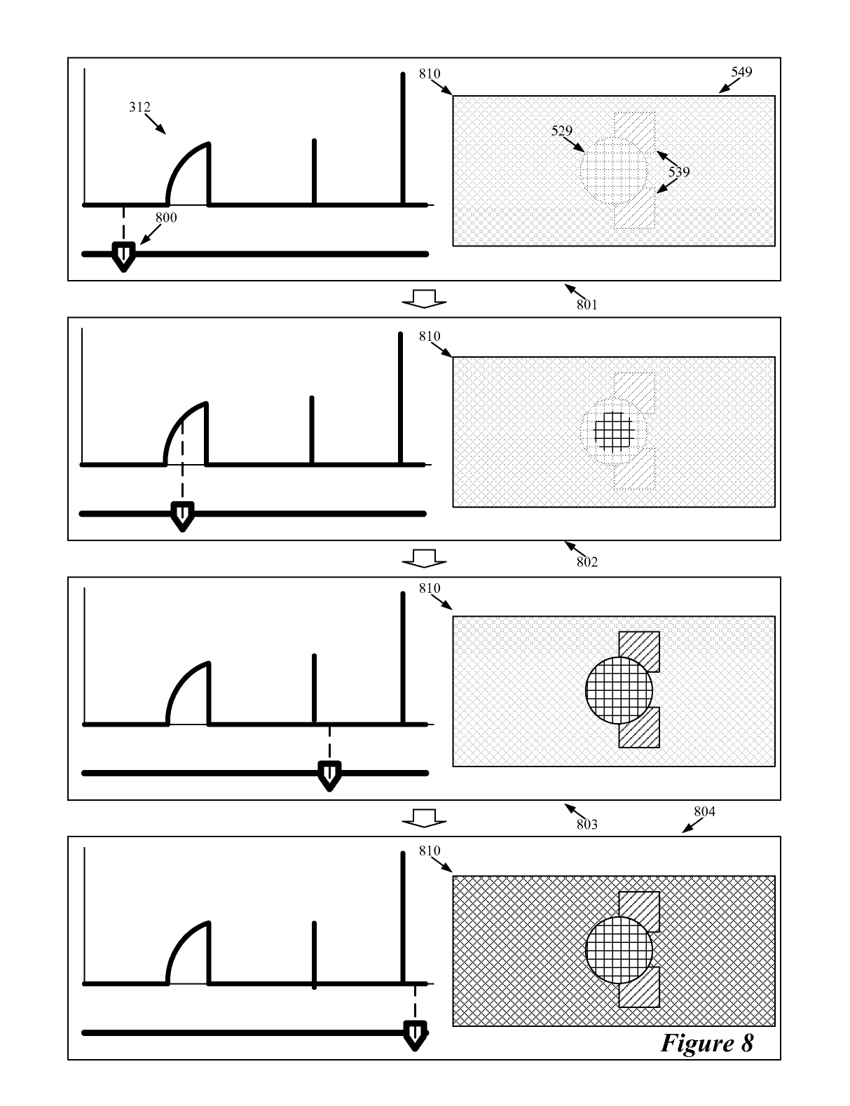

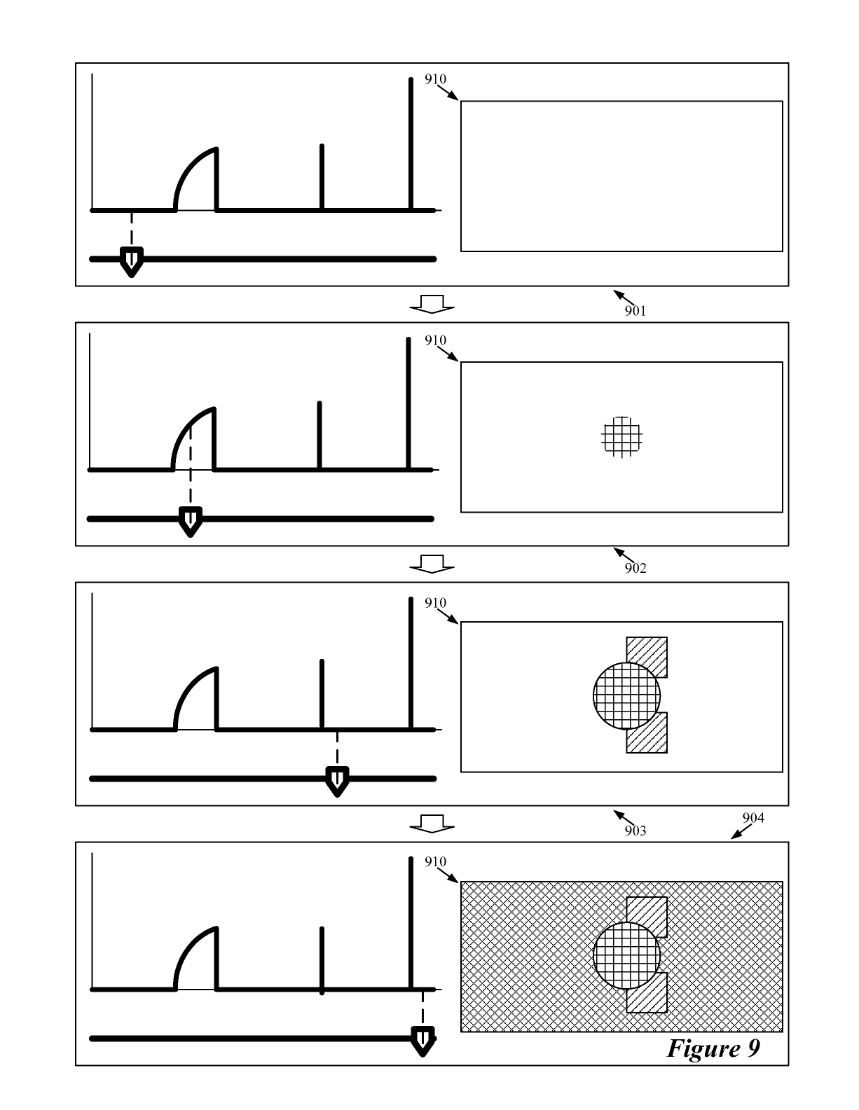

Two embodiments for fully displaying a foreground portion of an image and obscuring (e.g., graying out, removing, etc.) a background portion of the image are described with respect to FIGS. 8 and 9. FIG. 8 illustrates a depth display slider 800 of some embodiments for obscuring background layers by graying out the background layers. In each stage of the embodiment of FIG. 8, the foreground portion (as determined by the position of depth display slider 800) of an image that is derived from image data captured by a light field camera is shown clearly, while the background portion of the image is grayed out. The figure is illustrated in four stages 801-804. However, one of ordinary skill in the art will understand that the illustrated stages are based on settings of a control (i.e., depth display slider 800), not based on a sequence of events. Therefore the stages, in some embodiments, could occur in any order.

The stages 801-804 each include the histogram 312, a depth display slider 800, and an image 810 that changes based on the setting of the depth display slider 800. The histogram 312 is a histogram of image data representing the scene in FIG. 3. The image 810 in each stage 801-804 is an image of that scene generated from image data captured by a light field camera. The depth display slider 800 controls the dividing depth between the foreground and the background. Objects deeper than the depth indicated by the depth display slider 800 (e.g., objects represented on the histogram as being to the right of the corresponding depth display slider 800 location) are in the background. Objects less deep than the depth indicated by the depth display slider 800 (e.g., objects represented on the histogram as being to the left of the corresponding depth display slider 800 location) are in the foreground.

In stage 801, the depth display slider 800 is set to a location corresponding to a position on the histogram 312 representing a depth that is shallower than the depth of the sphere 322 (of FIG. 3). The sphere 322 is the closest object to the zero depth point in FIG. 3. Therefore, no objects in the image 810 are in the foreground in stage 801. Accordingly, the circle 529, partial squares 539, and wall 549 are all shown as grayed out in stage 801.

In stage 802, the depth display slider 800 is set to a location corresponding to a position on the histogram 312 representing a depth within the sphere 322 (of FIG. 3). As shown in stage 802, the depth display slider 800 position corresponds to a portion of the histogram 312 that identifies part of the sphere 322 (of FIG. 3). Accordingly, in image 810 in stage 802, the part of the circle 529 corresponding to the part of the sphere 322 (of FIG. 3) in the foreground is shown fully while the rest of the circle 529 corresponding to the part of the sphere in the background is grayed out. The sphere 322 is the closest object to the zero depth point in FIG. 3, so no other objects in the image 810 are in the foreground in stage 802. Accordingly, the partial squares 539, and wall 549 are all shown as grayed out in stage 802.

In stage 803, the depth display slider 800 is set to a location corresponding to a position on the histogram 312 representing a depth behind the front faces of cubes 324 (of FIG. 3). As shown in stage 803, the depth display slider 800 position corresponds to a portion of the histogram 312 that is in between the depth of the cubes 324 and the wall 326 of FIG. 3. Accordingly, in image 810 in stage 803, the circle 529 and the partial squares 539 in the foreground are shown fully while the wall 549 is grayed out.

In stage 804, the depth display slider 800 is set to a location corresponding to a position on the histogram 312 representing a depth behind the wall 326 (of FIG. 3). Accordingly, in image 810 in stage 803, the circle 529, the partial squares 539, and the wall 549 are all in the foreground and are shown fully while nothing in the image 810 is grayed out.

FIG. 9 illustrates multiple stages 901-904 of an alternate embodiment (to the embodiment of FIG. 8) in which portions of the image in the background are obscured by not being displayed, rather than being displayed as grayed out. The foregrounds of the images 910 in each stage 901-904 are the same as the corresponding foregrounds of the images 810 in each stage 801-804 in FIG. 8. One of ordinary skill in the art will understand that in some embodiments, the treatment of background portions of the image (e.g., grayed out, not shown at all, etc.) is a user settable option. In FIG. 9, the locations of the backgrounds in each stage are the same as the locations of the backgrounds in FIG. 8. However in the embodiment of FIG. 9 the background is completely hidden (i.e., not displayed at all).

In some embodiments, a default value of the depth display slider as described above (with respect to operation 720 of process 700 of FIG. 7) is set to a depth such as the depth of stages 803 of FIG. 8 and stage 903 of FIG. 9. That is, the default depth in such embodiments is set to a depth behind the objects in a particular layer of image data, but not behind the objects in a last layer of the image data. In other embodiments, the default depth is determined using other criteria (e.g., distance between peaks, etc.). In some embodiments, the default depth of the depth control is the maximum or minimum possible depth.

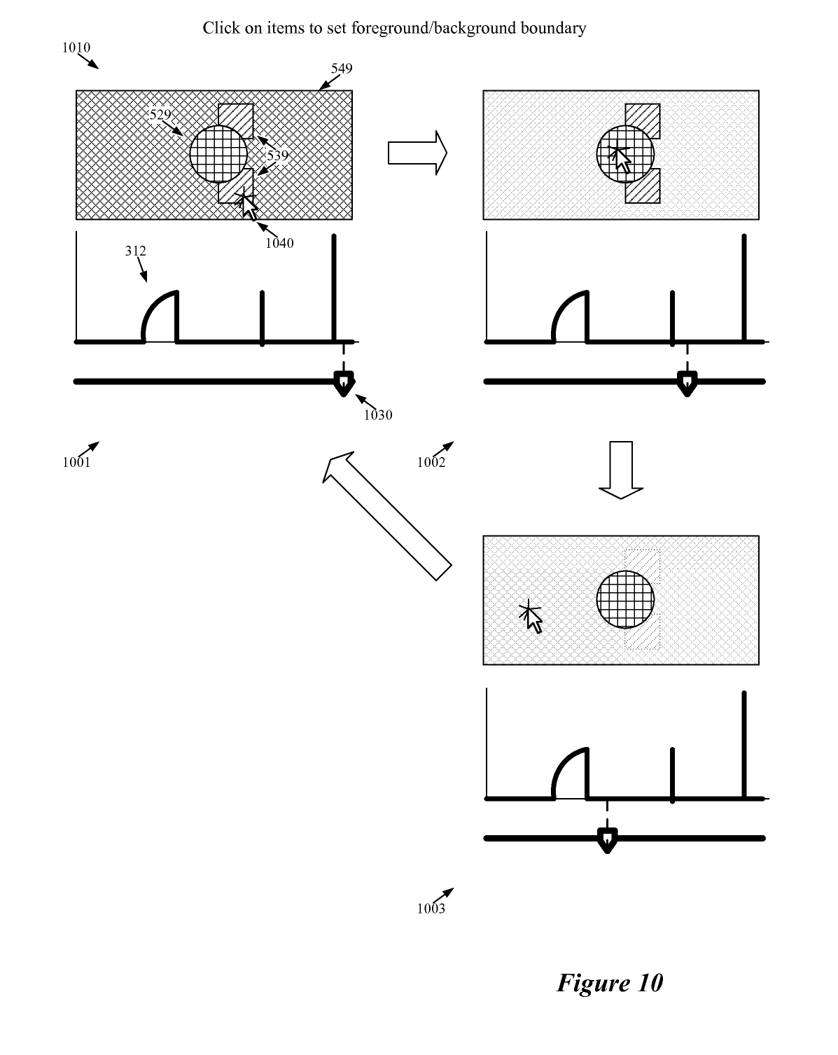

In some embodiments, either in addition to or instead of a depth display slider, the image organizing and editing application allows a user to select the foreground/background location by selecting individual objects within the image. FIG. 10 illustrates an embodiment in which the user selects a layer by selecting an object in that layer. The figure is shown in three stages 1001-1003. Each stage includes an image 1010, a histogram 312, a depth display slider 1030, and a clicking cursor 1040. The image 1010 is an image of the sphere 322, cubes 324, and wall 326 as seen in FIG. 3. The histogram 312 is a histogram corresponding to the image 1010, and the depth display slider 1030 is used in this embodiment as an indicator and alternate control of the depth of the foreground/background boundary. The stages 1001-1003 are shown as being cyclical; however this is for ease of description and is not a limitation of the inventions.

In stage 1001, the image 1010 is shown with histogram 312. In stage 1001, all objects are in the foreground as shown by depth display slider 1030 (i.e., the depth display slider 1030 is near the far right end of its scale). In stage 1001, the clicking cursor 1040 is selecting one of the partial squares 539 (e.g., a user is clicking on a mouse in order to select the partial squares 539). In this embodiment, the click on the object as shown in FIG. 10 represents a command by the user to bring the selected object (and all objects closer to the light field camera than the selected object) into the foreground. Upon receiving the selection of the partial square 539, the image organizing and editing application sets the division between the foreground and the background to be behind the layer of the selected object. Accordingly, the application transitions to stage 1002. In some embodiments, the slider 1030 moves to indicate the new depth of the foreground/background boundary.

In stage 1002 the wall 549 is grayed out and the partial squares 539 and the circle 529 are in the foreground. The partial squares 539 are in the foreground, in stage 1002, because the user selected one of them. The circle 529 is in the foreground because the image data includes distance information for each object in the scene captured by the light field camera. The distance information is used by the application to determine that the object that the circle 529 represents (i.e., the sphere 322 of FIG. 3) was closer to the light field camera than the selected objects that the partial squares 539 represent (i.e., cubes 324 of FIG. 3). Also as shown in FIG. 10, in some embodiments, the slider 1030 moves to indicate the new depth of the foreground/background boundary.

In stage 1002 the cursor 1040 is selecting the circle 529. As a result of the selection of the circle the application transitions to stage 1003. In stage 1003, the circle 529 is in the foreground and the partial squares 539 and the wall 549 are in the background. In stage 1003, the clicking cursor 1040 selects the wall 549 and the application transitions to stage 1001. Accordingly, the slider 1030 moves to indicate the new depth of the foreground/background boundary. One of ordinary skill in the art will understand that some embodiments allow a transition from any of these stages to any of the other stages based on what objects in the image are selected by the user. Although the control depicted is a clicking cursor, in other embodiments, other controls can be used to select objects in an image (e.g., a touch on a touch sensitive screen, selection via one or more keys on a keyboard, verbal commands to a speech processing device, etc.).

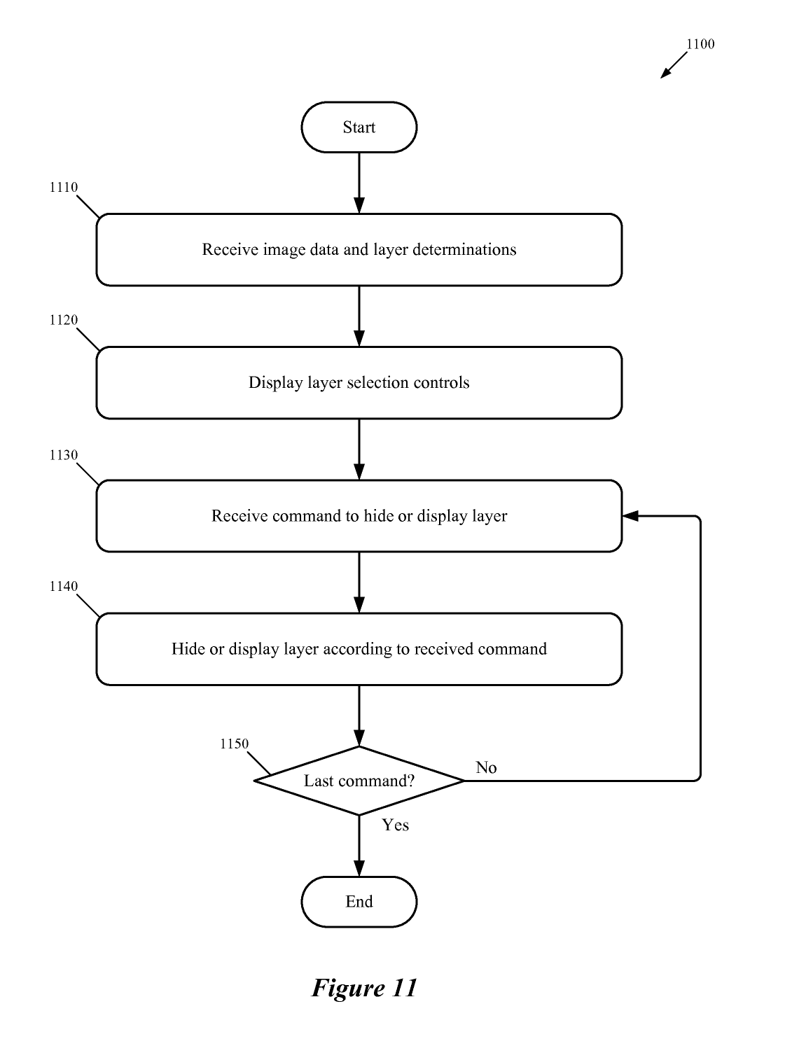

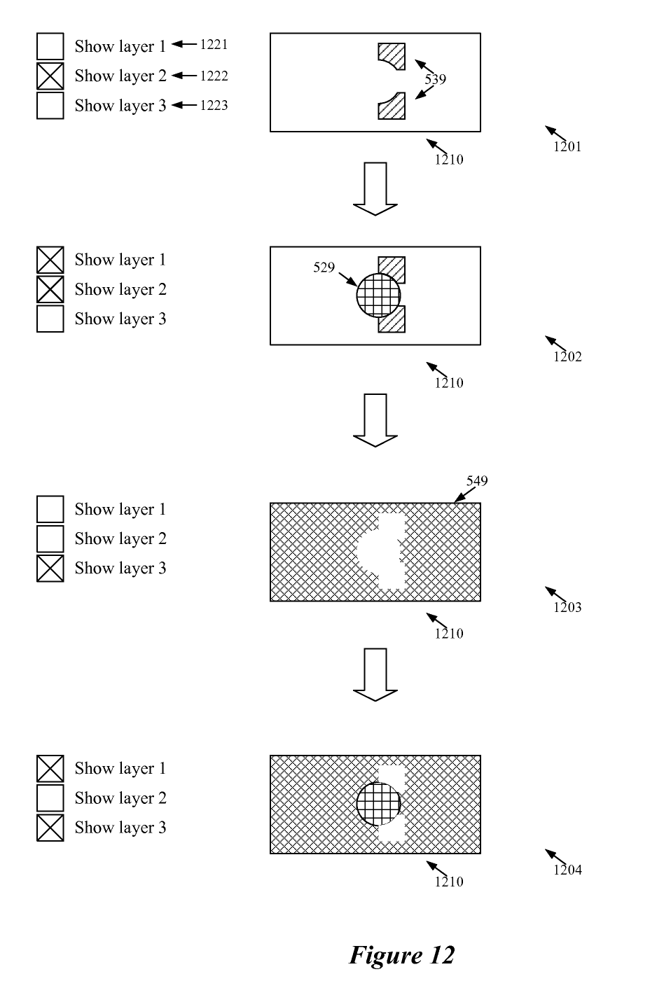

In addition to or instead of the depth display slider, some embodiments provide other controls for performing various operations on images of objects in different layers of the image data. One type of such controls is a type of control for hiding and revealing particular layers in the image data. FIG. 11 conceptually illustrates a process 1100 of providing and using layer selection controls. The layer selection controls of some embodiments allow a user to select which layers will be displayed and which layers will be hidden. The process 1100 receives (at 1110) image data and layer determinations. In some embodiments the layer determinations are sent by one module of an image organizing and editing application (e.g., from a layer determination module) and received by another module of the image organizing and editing application (e.g., a layer control display module). The process 1100 then displays (at 1120) a set of layer selection controls. In some embodiments, the number of layer selection controls depends on the number of identified layers. Some examples of layer selection controls are found in FIG. 12, described below.

The process then receives (at 1130) a command (e.g., from a user's interaction with the layer selection controls) to hide or display a layer of the image data. In some embodiments, a default setting is to display all layers and a command is received from the layer selection controls to hide a layer. In other embodiments the default setting is to hide all layers and a command is received to display a layer. The process 1100 then hides or displays (at 1140) the layer. The process 1100 then determines whether the received command was the last command. For example, the process 1100 of some embodiments waits until another command to hide or display a layer is received and the process 1100 ends when there is no possibility of another such command being received (e.g., when the image data file is closed or when the image organizing and editing application is shut down). When the process determines (at 1150) that the command received at 1130 was not the final command, the process returns to operation 1130 to receive the next command. When the process determines that the command was the final command (e.g., when the image data file is closed or the image organizing and editing application is shut down), the process 1100 ends.

### IV. Object Removal

FIG. 12 illustrates layer selection controls of some embodiments and their effects on a displayed image. In this figure, the layers are the same layers shown in FIG. 5. The figure is shown in four stages 1201-1204, however one of ordinary skill in the art will understand that the stages are not sequential in time, but rather reflect a sampling of the possible combinations of hidden and displayed layers. In some embodiments, the different stages could be performed in any order. Each stage includes a version of an image 1210 with different layers hidden and displayed. Each stage also includes a set of check box controls 1221-1223, each of which determines whether the corresponding layer will be hidden or displayed.

In stage 1201, the check box controls 1221 and 1223 for the first and third layers, respectively, are unchecked, while the check box control 1222 for the second layer is checked. Accordingly the image 1210 in stage 1201 displays the second layer (i.e., the layer containing partial squares 539), but not the first or third layers (i.e., the layers containing circle 529 and wall 549, respectively).

In stage 1202, the check box controls 1221 and 1222 for the first and second layers, respectively, are checked, while the check box control 1223 for the third layer is unchecked. Accordingly the image 1210 in stage 1202 displays the first and second layers (with circle 529 and partial squares 539), but not the third layer.

In stage 1203, the check box controls 1221 and 1222 for the first and second layers, respectively, are unchecked, while the check box control 1223 for the third layer is checked. Accordingly the image 1210 in stage 1203 displays the third layer (with wall 549), but not the first or second layers.

In stage 1204, the check box controls 1221 and 1223 for the first and third layers, respectively, are checked, while the check box control 1222 for the second layer is unchecked. Accordingly the image 1210 in stage 1204 displays the first and third layers (with circle 529 and wall 549), but not the second layer.

In FIG. 12, the controls are depicted as being check boxes; however other embodiments may use other controls to affect the visibility of the different layers. For example in some embodiments, a slider control determines whether a layer is fully visible, fully hidden, or transparent.

The images 1210 are illustrated as having voids where the layers are hidden. The voids represent the portions of the deeper layers that were not visible to the light field camera because objects closer to the light field camera blocked its view. However, a light field camera differs from an ordinary camera in more ways than just the ability to focus after shooting.

An ordinary camera captures data from a single viewpoint, i.e., the viewpoint of the center of the lens. For an image captured by an ordinary camera, if the image could be separated into layers by depth (e.g., with different depths identified by color or shape of the objects in each layer) the voids in each deeper layer would be identical to the portion of the image in the shallower layers. If one layer of an image taken by an ordinary camera included a circle of a particular size, there would be a circular void the same size in the layers behind the layer with the circle.

In contrast to an ordinary camera, however, at least some light field cameras capture data over an area rather than at a particular point. That is, the image data contains information about what the scene would look like from a variety of viewpoints spread over the area of the light field camera lens, rather than what the scene looked like from the viewpoint at the center of the camera lens as would be the case for an ordinary camera. The area of light capture allows images to be generated as though they were taken from viewpoints over the area of the light field camera lens. Some embodiments allow a user to move the viewpoint up, down, left, and right from the central viewpoint. Such a shift in perspective can reveal details previously hidden by the edge of an object in the image. As a consequence, the light field camera sees slightly around the edges of objects.

As a consequence of the image data being captured over an area, the image data may contain information about one layer that overlaps with information about another layer. Accordingly, in some embodiments, the voids in a deeper layer may be smaller than the portions of the image being removed when a shallower layer is hidden. Therefore, in some embodiments, removal of one layer of light field camera image data may reveal previously hidden parts of the image.

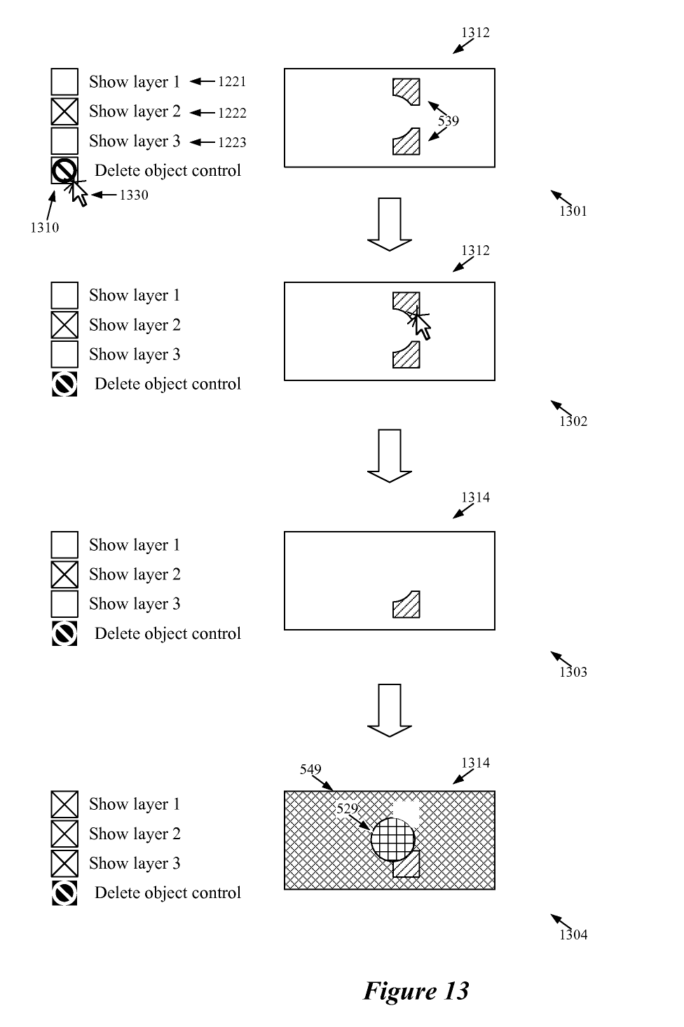

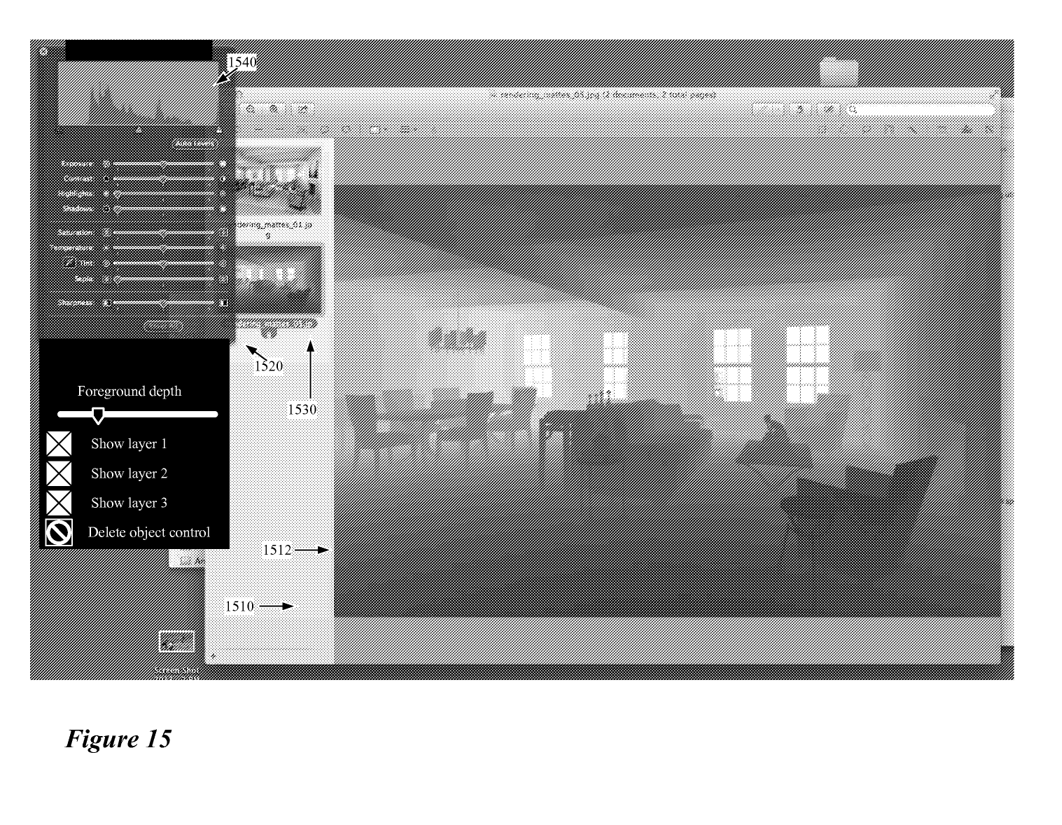

In some cases, a user might want to permanently remove an object from an image. The image organizing and editing application of some embodiments allows a user to do this. FIG. 13 illustrates the removal of an object from an image. The figure is illustrated in four stages 1301-1304. In each stage, a set of layer selection controls 1221-1223 and an object deletion toggle 1310 are shown. The controls are from an image organizing and editing application of some embodiments, for example, the image organizing and editing application illustrated in FIG. 15, below. In stages 1301-1302 an image 1312 is shown. In stages 1303-1304, the image has changed to become image 1314, with hidden layers in stage 1303 and all layers visible in stage 1304.

In stage 1301, a clicking cursor 1330 selects the object deletion toggle 1310 toggling it from off to on, as indicated by the inverted colors of the object deletion toggle 1310 in subsequent stages 1302-1304. The image 1312 is shown with the first and third layers hidden for ease of viewing. However in some embodiments, the object removal operation can be performed with the other layers displayed as well as the layer from which an object is being removed.

In stage 1302, the cursor 1330 selects the upper of the two partial squares 539. The selection of the object, with the object deletion toggle set to “on”, causes the image organizing and editing application to remove all contiguous parts of the object from the layer. The entire upper partial square 539 is therefore removed. There are connections (through the circle 529 and wall 549) in other layers between the upper and lower partial squares 539. However, because there is no connection in the second layer between the partial squares, the image organizing and editing application does not remove the lower partial square 539.

Accordingly, in stage 1303, the lower partial square 539 is present while the upper partial square 539 has been deleted in image 1314. In stage 1304, the layer selection controls 1221 and 1223 have been checked so the image 1314 shows all of its layers in stage 1304. There is a void in wall 549 where the upper partial square had been because the light field camera could not capture the wall 549 through the cubes. However, as described above with respect to FIG. 12, the void may be smaller than the removed object due to the light field camera's enlarged perspective.

Although the controls for removing an object in FIG. 13 are depicted as a toggle for activating the object removal tool and a click by a cursor on an object to remove the object, one of ordinary skill in the art will understand that other types of controls are within the scope of the invention. For example, in some embodiments a click on an object in conjunction with a held down key on a keyboard could command the removal of an object, a touch to a touch sensitive device could command the removal of an object, etc.

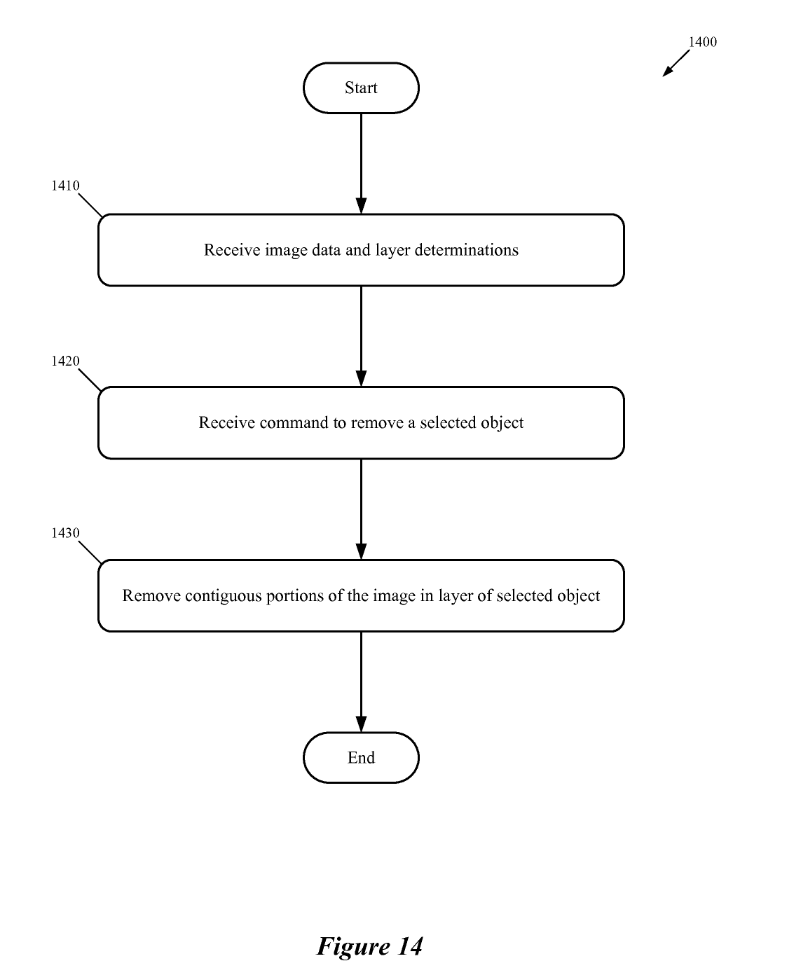

FIG. 14 conceptually illustrates a process 1400 for removing an object from an image. The process 1400 receives (at 1410) image data and layer determinations. The process 1400 then receives (at 1420) a command to remove an object. The process 1400 then removes (at 1430) contiguous portions of the image in the layer of the selected object. In some embodiments, the process 1400 does not remove portions of an image that are in other layers than the object. The process 1400 of some embodiments does not remove portions of a layer that are connected to the selected portion only through portions of the image in another layer. For example, in FIG. 13, the partial squares 539 were visually connected to each other by the circle 529 in the first layer and by the wall 549 in the third layer, but only the selected cube was removed because they had no connection in their own layer (the second layer).

### V. Image Organizing and Editing Application

FIG. 15 illustrates an image organizing and editing application 1500 of some embodiments. The figure includes image organizing and editing application 1500, an image display area 1510, image adjustment controls 1520, and image selection thumbnails 1530 and histogram 1540. The image display area 1510 shows a full sized image of the thumbnail selected in the image selection thumbnails 1530 area. The image adjustment controls 1520 allow a user to adjust the exposure, contrast, highlights, shadows, saturation, temperature, tint, and sharpness of the image. The image selection thumbnails 1530 allow a user to switch between multiple images. The histogram 1540 is a histogram of depth versus fraction of the image at the given depths. The histogram 1540 has a value of zero (i.e., nothing in the image is at that depth) until the depth axis reaches the depth of the first object in the image data. Then the portion of the image at the given depth begins to rise to a peak, followed by a valley, and further peaks and valleys.

The image display area 1510 shows an image 1512 generated from image data taken by a light field camera. The image data has been evaluated for the depth information. The displayed image 1512 is not a direct visual representation of the captured scene; instead it is a depth representation of the scene. The image organizing and editing application 1500 has set each pixel in the image 1512 to a brightness level that represents the depth of that pixel in the original image. The greater the depth of the pixel, the brighter the pixel is. Therefore the darkest areas of the image (the table and chair at the lower right) represent the closest objects to the light field camera when the image data was captured. Whatever is outside the windows of the image 1512 were the farthest objects from the light field camera, so they are shown as bright white. The chairs on the left side of the image 1512 are at a middle distance, so they are shown as grey.

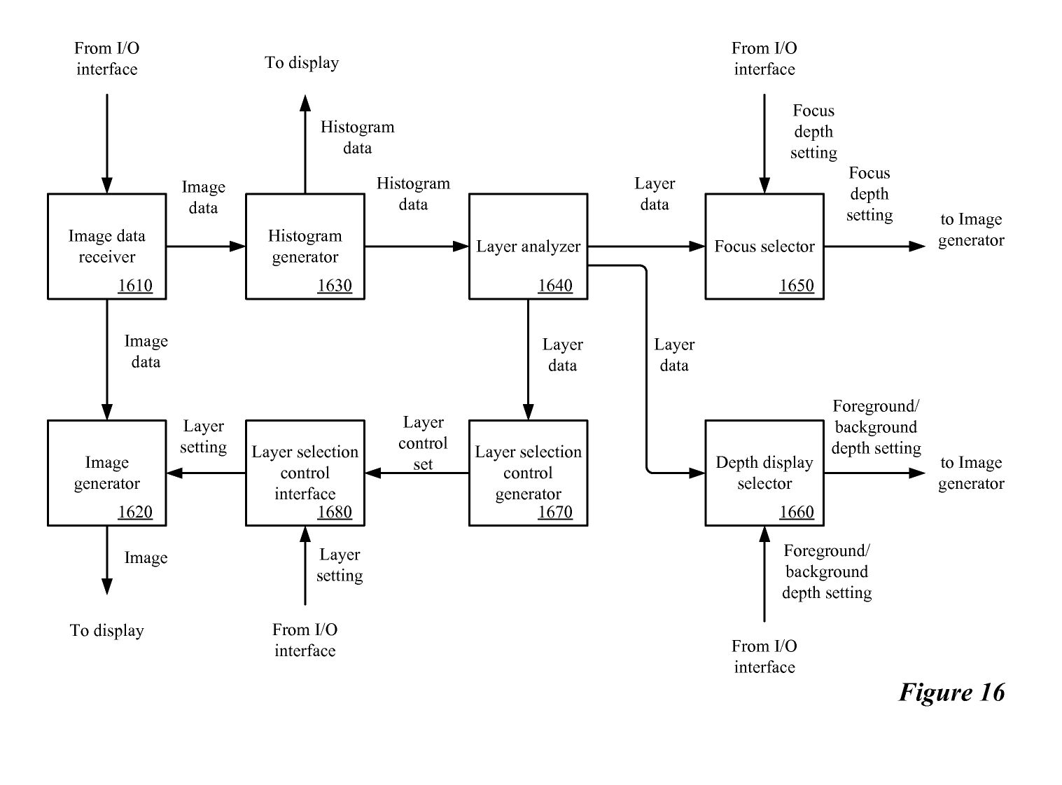

FIG. 16 conceptually illustrates a software architecture of some embodiments. The figure includes image data receiver 1610, image generator 1620, histogram generator 1630, layer analyzer 1640, focus selector 1650, depth display selector 1660, layer selection control generator 1670, and layer selection control interface 1680.

The image data receiver 1610 receives data in a form produced by a light field camera. This data is received from outside the application (e.g., from a USB or other data port) or is received from a memory storage of the device on which the application runs. The image data receiver 1610 then passes the image data on to the image generator 1620 and the histogram generator 1630.

The image generator 1620 receives the image data from image data receiver 1610 and various settings from the focus selector 1650, depth display selector 1660 and the layer selection control interface 1680. Using the received image data and the settings, the image generator generates an image (e.g., a jpg, tiff, etc.) and sends the image to a display.

The histogram generator 1630 receives the image data from image data receiver 1610 and uses the image data to generate a histogram of depth versus portion of the image at each depth. The histogram generator 1630 then provides the histogram data to the layer analyzer 1640 and to a display to display an image of the histogram (in some embodiments, the user determines whether or not to display an image of the histogram).

The layer analyzer 1640 receives the histogram data and determines a set of layers based on the received histogram data. The layer analyzer then passes the layer data on to the focus selector 1650, the depth display selector 1660, and the layer selection control generator 1670.

The focus selector 1650 receives layer data from the layer analyzer in some embodiments and receives user selections of focus depths from an input output (I/O) interface (e.g., a user selection and movement of a focus control slider using a mouse or a touch sensitive screen). The focus selector 1650 determines what depth to focus on when producing an image from the image data from the light field camera. The focus selector 1650 in some embodiments determines a default focus depth based on the layer data from the layer analyzer. In other embodiments the focus selector is set to a default level without receiving layer data. The focus selector 1650 of some embodiments provides a tool to the user to allow the user to change the default focus depth. The focus selector 1650 of some embodiments sends focus depth settings (however derived) to the image generator 1620.

The depth display selector 1660 receives layer data from layer analyzer 1640 and receives user input from an I/O of the device. The depth display selector 1660 uses the received layer data to set a default foreground/background setting (e.g., the setting in stage 803 of FIG. 8). The depth display selector 1660 of some embodiments also provides a control (e.g., a slider control) to allow the user to change the setting of the foreground/background boundary. The depth display selector 1660 of some embodiments provides settings (however derived) to the image generator 1620.

The layer selection control generator 1670 determines the number and depth ranges of the layers based on layer data received from layer analyzer 1640. The layer selection control generator 1670 then provides a layer control set (e.g., 3 controls for 3 layers, 4 controls for 4 layers, etc.) to the layer selection control interface 1680.

The layer selection control interface 1680 receives the layer control set from the layer selection control generator 1670 and receives layer settings from a user via an I/O interface of the device. The layer settings in some embodiments determine which layers will be displayed and which layers will not be displayed. The layer selection control interface 1680 then provides the layer settings to the image generator 1620.

The image generator 1620, as mentioned above, receives the image data and a variety of settings. In some embodiments, the image data acts as the raw material that the image generator uses to generate an image. The focus depth setting from the focus selector 1650 determines the depth at which to focus the image (i.e., what depth to place in focus of all the depths captured by the light field camera). The layer settings from the layer selection control interface 1680 determine whether the image generator will generate the image with all layers visible or one or more layers not displayed. The foreground/background depth setting will determine at what depth the image generator should begin graying out portions of the image that are set to be displayed by the layer settings.

While many of the features of image editing, viewing, and organizing applications of some embodiments have been described as being performed by one module (e.g., image generator 1620, layer selection control interface 1680, etc.), one of ordinary skill in the art will recognize that the functions described herein might be split up into multiple modules. Similarly, functions described as being performed by multiple different modules might be performed by a single module in some embodiments (e.g., the image generator 1620 might be combined with the image receiver 1610, etc.).

### VI. Mobile Device

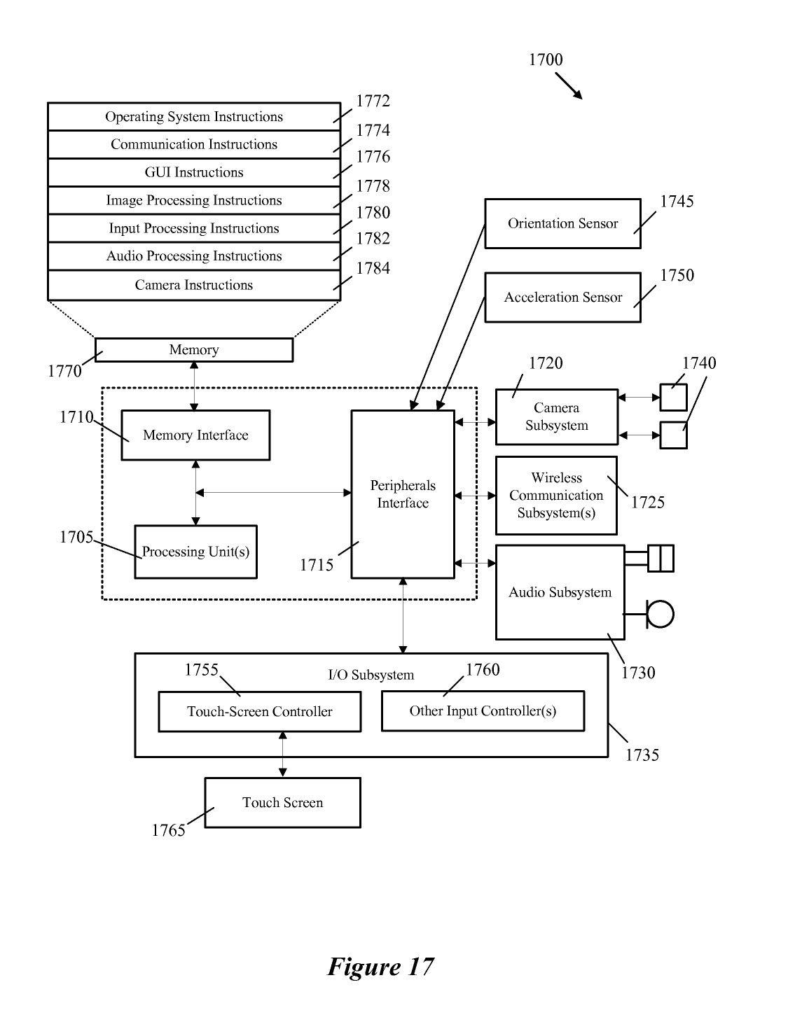

The image organizing, editing, and viewing applications of some embodiments operate on mobile devices, such as smartphones (e.g., iPhones®) and tablets (e.g., iPads®). FIG. 17 is an example of an architecture 1700 of such a mobile computing device. Examples of mobile computing devices include smartphones, tablets, laptops, etc. As shown, the mobile computing device 1700 includes one or more processing units 1705, a memory interface 1710 and a peripherals interface 1715.

The peripherals interface 1715 is coupled to various sensors and subsystems, including a camera subsystem 1720, a wireless communication subsystem(s) 1725, an audio subsystem 1730, an I/O subsystem 1735, etc. The peripherals interface 1715 enables communication between the processing units 1705 and various peripherals. For example, an orientation sensor 1745 (e.g., a gyroscope) and an acceleration sensor 1750 (e.g., an accelerometer) is coupled to the peripherals interface 1715 to facilitate orientation and acceleration functions.

The camera subsystem 1720 is coupled to one or more optical sensors 1740 (e.g., a charged coupled device (CCD) optical sensor, a complementary metal-oxide-semiconductor (CMOS) optical sensor, etc.). The camera subsystem 1720 coupled with the optical sensors 1740 facilitates camera functions, such as image and/or video data capturing. The wireless communication subsystem 1725 serves to facilitate communication functions. In some embodiments, the wireless communication subsystem 1725 includes radio frequency receivers and transmitters, and optical receivers and transmitters (not shown in FIG. 17). These receivers and transmitters of some embodiments are implemented to operate over one or more communication networks such as a GSM network, a Wi-Fi network, a Bluetooth network, etc. The audio subsystem 1730 is coupled to a speaker to output audio (e.g., to output voice navigation instructions). Additionally, the audio subsystem 1730 is coupled to a microphone to facilitate voice-enabled functions, such as voice recognition (e.g., for searching), digital recording, etc.

The I/O subsystem 1735 involves the transfer between input/output peripheral devices, such as a display, a touch screen, etc., and the data bus of the processing units 1705 through the peripherals interface 1715. The I/O subsystem 1735 includes a touch-screen controller 1755 and other input controllers 1760 to facilitate the transfer between input/output peripheral devices and the data bus of the processing units 1705. As shown, the touch-screen controller 1755 is coupled to a touch screen 1765. The touch-screen controller 1755 detects contact and movement on the touch screen 1765 using any of multiple touch sensitivity technologies. The other input controllers 1760 are coupled to other input/control devices, such as one or more buttons. Some embodiments include a near-touch sensitive screen and a corresponding controller that can detect near-touch interactions instead of or in addition to touch interactions.

The memory interface 1710 is coupled to memory 1770. In some embodiments, the memory 1770 includes volatile memory (e.g., high-speed random access memory), non-volatile memory (e.g., flash memory), a combination of volatile and non-volatile memory, and/or any other type of memory. As illustrated in FIG. 17, the memory 1770 stores an operating system (OS) 1772. The OS 1772 includes instructions for handling basic system services and for performing hardware dependent tasks.

The memory 1770 also includes communication instructions 1774 to facilitate communicating with one or more additional devices; graphical user interface instructions 1776 to facilitate graphic user interface processing; image processing instructions 1778 to facilitate image-related processing and functions; input processing instructions 1780 to facilitate input-related (e.g., touch input) processes and functions; audio processing instructions 1782 to facilitate audio-related processes and functions; and camera instructions 1784 to facilitate camera-related processes and functions. The instructions described above are merely exemplary and the memory 1770 includes additional and/or other instructions in some embodiments. For instance, the memory for a smartphone may include phone instructions to facilitate phone-related processes and functions. Additionally, the memory may include instructions for an image organizing, editing, and viewing application. The above-identified instructions need not be implemented as separate software programs or modules. Various functions of the mobile computing device can be implemented in hardware and/or in software, including in one or more signal processing and/or application specific integrated circuits.

While the components illustrated in FIG. 17 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 17 may be split into two or more integrated circuits.

### VII. Computer System

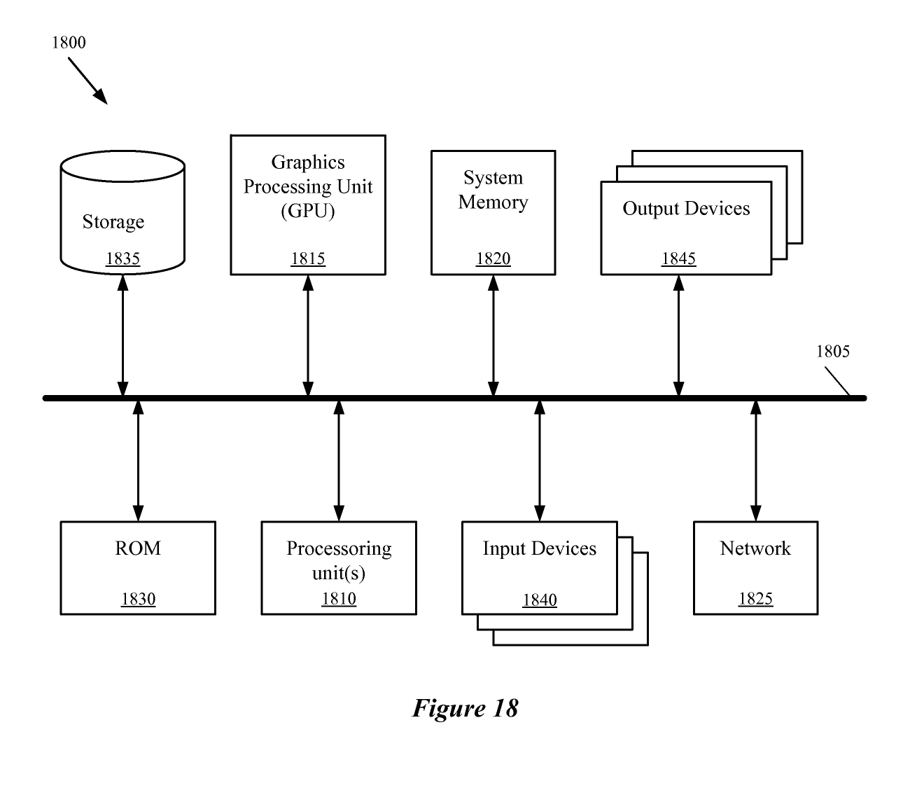

FIG. 18 conceptually illustrates another example of an electronic system 1800 with which some embodiments of the invention are implemented. The electronic system 1800 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 1800 includes a bus 1805, processing unit(s) 1810, a graphics processing unit (GPU) 1815, a system memory 1820, a network 1825, a read-only memory 1830, a permanent storage device 1835, input devices 1840, and output devices 1845.

The bus 1805 collectively represents all system, peripheral, and chipset buses that communicatively connect the numerous internal devices of the electronic system 1800. For instance, the bus 1805 communicatively connects the processing unit(s) 1810 with the read-only memory 1830, the GPU 1815, the system memory 1820, and the permanent storage device 1835.

From these various memory units, the processing unit(s) 1810 retrieves instructions to execute and data to process in order to execute the processes of the invention. The processing unit(s) may be a single processor or a multi-core processor in different embodiments. Some instructions are passed to and executed by the GPU 1815. The GPU 1815 can offload various computations or complement the image processing provided by the processing unit(s) 1810.

The read-only-memory (ROM) 1830 stores static data and instructions that are needed by the processing unit(s) 1810 and other modules of the electronic system. The permanent storage device 1835, on the other hand, is a read-and-write memory device. This device is a non-volatile memory unit that stores instructions and data even when the electronic system 1800 is off. Some embodiments of the invention use a mass-storage device (such as a magnetic or optical disk and its corresponding disk drive) as the permanent storage device 1835.

Other embodiments use a removable storage device (such as a floppy disk, flash memory device, etc., and its corresponding drive) as the permanent storage device. Like the permanent storage device 1835, the system memory 1820 is a read-and-write memory device. However, unlike storage device 1835, the system memory 1820 is a volatile read-and-write memory, such a random access memory. The system memory 1820 stores some of the instructions and data that the processor needs at runtime. In some embodiments, the invention's processes are stored in the system memory 1820, the permanent storage device 1835, and/or the read-only memory 1830. For example, the various memory units include instructions for processing multimedia clips in accordance with some embodiments. From these various memory units, the processing unit(s) 1810 retrieves instructions to execute and data to process in order to execute the processes of some embodiments.

The bus 1805 also connects to the input and output devices 1840 and 1845. The input devices 1840 enable the user to communicate information and select commands to the electronic system. The input devices 1840 include alphanumeric keyboards and pointing devices (also called “cursor control devices”), cameras (e.g., webcams), microphones or similar devices for receiving voice commands, etc. The output devices 1845 display images generated by the electronic system or otherwise output data. The output devices 1845 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 18, bus 1805 also couples electronic system 1800 to a network 1825 through a network adapter (not shown). In this manner, the computer can be a part of a network of computers (such as a local area network (“LAN”), a wide area network (“WAN”), or an Intranet, or a network of networks, such as the Internet. Any or all components of electronic system 1800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

What is claimed is:

1. A method of editing image data produced by a light field camera, the method comprising:
receiving the image data produced by the light field camera;
generating histogram data based on an amount of image data representing each of a plurality of depth levels in the image data;
determining a plurality of layers of the image data based on the generated histogram data;
providing a set of controls for the plurality of layers of the image data; and
generating an image based on the image data and settings of the set of controls.

2. The method of claim 1, wherein the set of controls comprises a control for hiding at least one layer of the image data when generating the image.

3. The method of claim 2, wherein generating the image comprises generating the image without displaying the hidden layer of the image data.

4. The method of claim 1, wherein the set of controls comprises a control for each of a plurality of identified layers.

5. The method of claim 1 further comprising displaying a graphical representation of the histogram data.

6. The method of claim 1, wherein the image is comprised of pixels, the method further comprising:
receiving a selection of a location in the image, wherein the location identifies a portion of the image in a particular layer of the image; and
removing from the image a plurality of pixels that are (i) in the particular layer, and (ii) contiguously connected to the selected location by portions of the image in the particular layer.

7. The method of claim 6, wherein the removing does not remove pixels that are not connected to the selected location by portions of the image in the particular layer.

8. The method of claim 6, wherein receiving the selection of a location in the image comprises receiving a click on the location in the image with a cursor control device.

9. The method of claim 6 further comprising receiving a selection of an object removal control before receiving the selection of the location in the image.

10. The method of claim 6, wherein removing the plurality of pixels produces a void in the image smaller than the area of pixels removed.

11. A method of editing image data produced by a light field camera, the method comprising:
receiving the image data produced by the light field camera;
identifying a depth for each of a plurality of portions of the image data;
determining a threshold depth; and
generating an image, based on the image data, with portions of the image that represent depths beyond the threshold depth obscured.

12. The method of claim 11, wherein the obscured portions of the image are grayed out.

13. The method of claim 12, wherein non-obscured portions of the image are displayed without being grayed out.

14. The method of claim 11 further comprising determining an initial threshold depth based on a set of histogram data that relates a set of depths of the image to portions of the image at each particular depth of the set of depths.

15. The method of claim 11 further comprising providing a control for setting the threshold depth, wherein determining the threshold depth comprises determining a setting of the control.

16. The method of claim 15, wherein the control is a first control, the method further comprising providing a second control for setting a depth of focus for the image.

17. The method of claim 11, wherein the obscured portions of the image are not displayed.

18. A non-transitory machine readable medium storing a program which when executed by at least one processing unit edits image data produced by a light field camera, the program comprising sets of instructions for:
receiving the image data produced by the light field camera;
generating histogram data based on an amount of image data representing each of a plurality of depth levels in the image data;
determining a plurality of layers of the image data based on the generated histogram data;
providing a set of controls for the plurality of layers of the image data; and
generating an image based on the image data and settings of the set of controls.

19. The non-transitory machine readable medium of claim 18, wherein the set of controls comprises a control for hiding at least one layer of the image data when generating the image.

20. The non-transitory machine readable medium of claim 19, wherein the set of instructions for generating the image comprises a set of instructions for generating the image without displaying the hidden layer of the image data.

21. The non-transitory machine readable medium of claim 18, wherein the set of controls comprises a control for each of a plurality of identified layers.

22. The non-transitory machine readable medium of claim 18, wherein the program further comprises a set of instructions for displaying a graphical representation of the histogram data.

23. The non-transitory machine readable medium of claim 18, wherein the image is comprised of pixels, wherein the program further comprises sets of instructions for:
receiving a selection of a location in the image, wherein the location identifies a portion of the image in a particular layer of the image; and
removing from the image a plurality of pixels that are (i) in the particular layer, and (ii) contiguously connected to the selected location by portions of the image in the particular layer.
